(19) United States
(12) Patent Application Publication
(10) Pub. No.: US 2008/0224575 A1
(43) Pub. Date: Sep. 18, 2008

(54) Servomotor neutral position setting apparatus of wireless remote-control model

(76) Inventor: Shigetada Taya, Yokohama city (JP)

Correspondence Address: TROXELL LAW OFFICE PLLC, SUITE 1404, 5205 LEESBURG PIKE, FALLS CHURCH, VA, 22041, US

(21) Appl. No.: 12/071,751

(22) Filed: Feb. 26, 2008

(30) Foreign Application Priority Data
Feb. 26, 2007 (JP) 2007-045460

(51) Int. Cl. H02K 29/06; H02P 6/16

(52) U.S. Cl. 310/68 B; 318/626

(57) ABSTRACT

A servomotor neutral position setting apparatus of a wireless remote-control model comes with a simple structure that embeds a servo rudder piece into an output shaft of a servomotor to set a neutral position with high precision.

### BACKGROUND OF THE INVENTION

1. Field of the Invention

The present invention relates to a servo apparatus used for controlling a wireless remote-control model, and more particularly to a servomotor neutral position setting apparatus of a wireless remote-control model that can set a neutral position of a servo rudder piece installed on a servomotor output shaft easily and precisely.

2. Description of the Related Art

Wireless controlled models such as remote-control helicopters or vehicles are also known as wireless models or wireless remote controls, not only applied in the area of amateur hobbies, but also used extensively in many industries. A wireless remote-control model generally includes a signal receiver for receiving instruction signals from a signal transmitter, and a plurality of electronic control machines (or operating/controlling machines), a servomotor, a speed controller, a gyroscope, a battery for controlling the flying and driving of the wireless remote-control model.

The aforementioned operation is controlled by a servo apparatus composed of a servomotor, and rotary components of a servo rudder piece installed at an output shaft of the servomotor. The servo apparatus reduces the rotation speed of the motor and drives the output shaft to rotate the servo rudder piece on the output shaft, and controls the controlled components by a link rod connected to the servo rudder piece. The output shaft of the motor is connected to a rotary axle of a potential meter (rheostat) for comparing the signal formed by the corresponding resistance value of the potential meter and the received signal represented by a rotation angle of the output shaft, and corresponding the operating magnitude of the signal transmitter side to control the rotation of the motor precisely.

In this type of servo apparatuses, the precision of connecting the output shaft and the servo rudder piece of the motor directly affects the control performance. The application of precisely setting a neutral position of a servo apparatus in this type of servomotors has been disclosed in a patent literature (Japan Patent Laid Open Publication No. 2004-243026 of KOKAI gazette).

Referring to FIG. 10 for a schematic model view of a prior art servo apparatus, an output shaft 2 of a servomotor 1 is substantially in a cylindrical shape, and an external circumferential longitudinal groove known as serration (hereinafter refereed to as “external serration”) 3 is formed around its periphery. Further, the servo rudder piece 4 forms an embedding hole having an internal circumferential longitudinal groove (hereinafter referred to as “internal serration”) 5 for embedding the external serration 3 of the output shaft 2. The internal serration 5 of the servo rudder piece 4 is embedded into an external circumferential longitudinal groove of the output shaft 2 of the servomotor 1, and the servo rudder piece 4 is fixed around the output shaft 2 of the servomotor 1 and rotated within a predetermined angular range. Further, the output shaft 2 has a potential meter 1A disposed at the same axis of the output shaft 2.

In the rotation within the foregoing angular range, such as in a preferred embodiment of controlling the rudder, it is necessary to set a neutral position as a standard for left and right turns of the rudder. In view of the described above, the neutral position of the servomotor 1 is determined by the resistance value of a potential meter and corresponding to a neutral signal pulse of the standard. However, the rotation angle of the output shaft 2 rotated with respect to the potential meter cannot be determined because the neutral position cannot be achieved due to the error of the resistance value of the potential meter.

Referring to FIG. 11 for a schematic view of a servo rudder piece installed to the output shaft 2 of a servomotor 1 and deviated from the neutral position, and the angle of the internal serration 5 being engaged with the external serration 3 (which is an angle on a plane parallel to the rotary surface) is determined by a step angle (which is a central angle in a tooth-groove unit) of the discrete serration, even when the servo rudder piece is installed at the most appropriate position of the output shaft 2 and the servomotor 1 is situated at a neutral position. In FIG. 11, θc is the desired setting central angle (at a neutral position), θo is a central line on a rotary surface of the servo rudder piece 4 when one of the teeth is moving, and θs is a minimum angle deviated from the central angle θc.

In general, the step angle of the teeth formed on an output shaft of a widely used servomotor is approximately 15 degrees (θo), and the servo rudder piece cannot be installed with a precision smaller than this angle. As a result, the angle θs deviated from the central angle θc is approximately (15/2) degrees to the left or to the right. Therefore, there will be a difference between the left turn and right turn movements according to the connection between the servo rudder piece 4 and the controlled portion, or there will be a difference between the maximum rotation angle to the left or to the right even if the neutral pulse is moved to obtain the best installation angle.

In a patent literature 1, a two-section serrated structure named angular adjustment mechanism is installed between the output shaft of the servomotor and the servo rudder piece for achieving the effect of setting the neutral position precisely, but the angular adjusting mechanism generally comes with a very complicated structure and requires many components.

### SUMMARY OF THE INVENTION

It is a primary objective of the present invention to provide a servomotor neutral position setting apparatus of a wireless remote-control model, wherein a simple structure of a servo rudder piece being embedded onto an output shaft of a servomotor can set neutral position with a high precision.

The wireless remote-control model of the invention comprises: a servomotor, having an output shaft that rotates within a predetermined angular range in a frame body; a servo rudder piece, having an embedding hole for embedding the output shaft, and a latching hole for latching a link rod connected to a controlled component; and a potential meter, installed and rotated coaxially with the output shaft of the servomotor, and the portion where the output shaft of the servomotor embedded into at least one embedding hole of the servo rudder piece is a prism, and at least one surface of the external sidewall of the prism has a convex bar formed in a direction parallel to an inserting direction of the embedding hole of the servo rudder piece.

The embedding hole of the servo rudder piece is an angular hole for embedding said output shaft of said servomotor prism, and at least one surface of the internal sidewall of the angular sidewall has a concave bar formed in the same direction of the convex bar on the external sidewall of the output shaft and embedded to the convex bar.

A fixed-side rotation angle limit component is disposed on a lateral side of the frame body and has for limiting a maximum rotation angle in a direction and an opposite direction of the output shaft of the servomotor, while a rotary-side rotation angle limit component is disposed on a lateral side of the output shaft for limiting a maximum rotation angular position in a direction and a maximum rotation angle in an opposite direction of the output shaft.

The median of each output value of the potential meter is determined to be a standard neutral position of the output shaft of the servomotor, when the output shaft of the servomotor is situated at a position of the maximum rotation angle in the direction and the opposite direction.

Further, the prism is a quadrangular prism, and the cross-section of the convex bar is substantially in a circular or elliptic shape, and the prism is in a shape of having a lateral portion coupled to an external sidewall of the prism and buried into the external side wall.

The present invention can provide a wireless remote-control model with a high precision of the installation of a servomotor and a servo rudder piece to enhance the mechanical precision of a control system, and make the assembling process, the setup of a neutral position, and the mass production of various types of wireless remote-control model more easily without or with very small discrepancy, so as to improve a flight or driving the performance.

The above and other objects, features and advantages of the present invention will become apparent in the following detailed description of the preferred embodiments together with the attached drawings for the detailed description of the invention.

Preferred embodiments of this invention have been illustrated in the drawings, but it should be pointed out that modifications or variations of some elements of the invention or the arrangement of elements are conceivable within the scope of the patent claims of this invention.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a perspective view of important portions of a servomotor neutral position setting apparatus of a wireless remote-control model in accordance with a first preferred embodiment of the present invention;

FIG. 2 is a schematic view of an example of a stop mechanism for limiting the maximum rotation angle of a servomotor;

FIG. 3 is a schematic view of an external appearance of a potential meter;

FIG. 4 is an oblique view of a servomotor output shaft with a correction in accordance with the present invention;

FIG. 5 is a schematic view of an output pulse content of a signal transmitter and a position of a servo rudder piece when the neutral position is set automatically and simply in accordance with a preferred embodiment of the present invention;

FIG. 6 is a schematic view of a system assembly when a wireless remote-control model sets a neutral position automatically and precisely in accordance with a preferred embodiment of the present invention;

FIG. 7 is a flow chart of a sequence for setting a neutral position of a wireless remote-control model automatically and precisely in accordance with a preferred embodiment of the present invention;

FIG. 8 is a schematic view of the content of an input pulse from a signal transmitter and the position of a servo rudder piece when a neutral position is set automatically and precisely in accordance with a preferred embodiment of the present invention;

FIG. 9 is an overall view of a radio control helicopter applicable for a wireless remote-control model in accordance with the present invention;

FIG. 10 is a schematic view of a servo apparatus assembly in accordance with a preferred embodiment of the present invention; and

FIG. 11 is a schematic view of a servo rudder piece installed to servomotor output shaft and deviated from the neutral position.

### DETAILED DESCRIPTION OF THE PREFERRED EMBODIMENTS

In the related figures of a preferred embodiment of a wireless remote control helicopter in accordance with the present invention, the same referring numerals are used for the same components for the illustration of the invention.

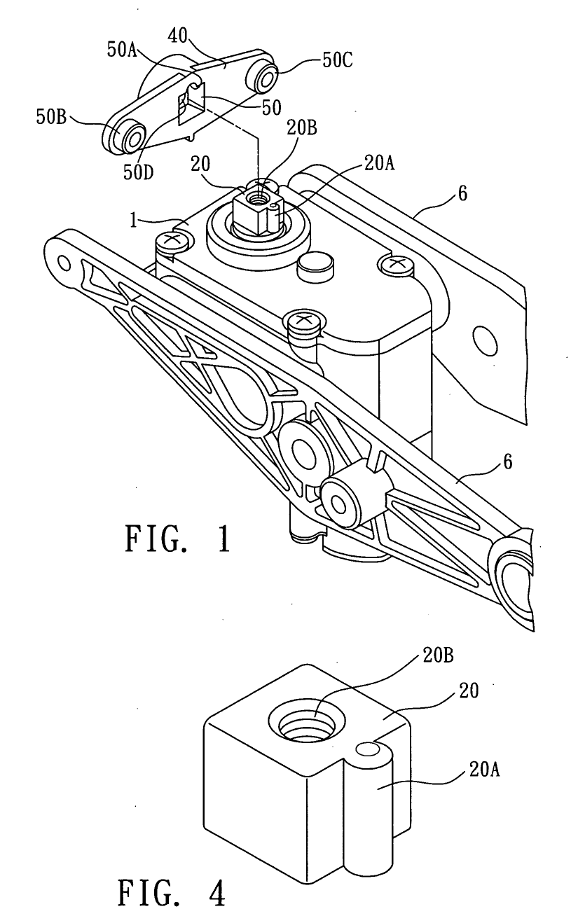

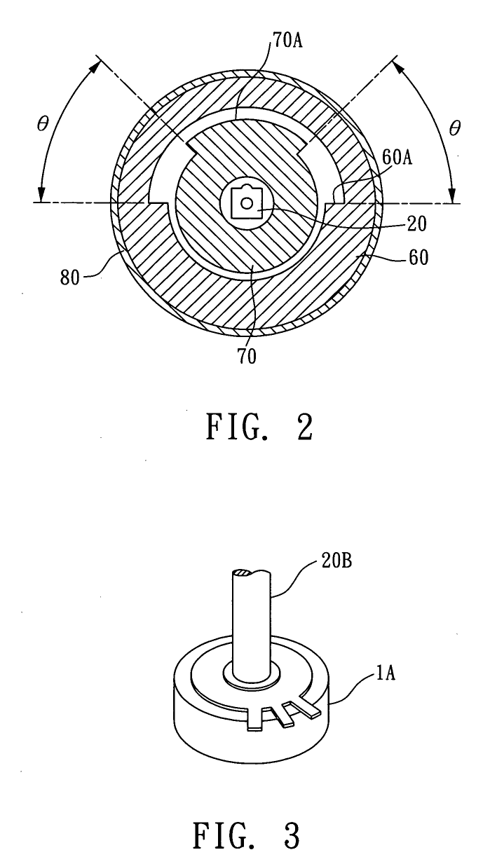

Refer to FIG. 1 for an oblique view of importation portions of a servomotor neutral position setting apparatus of a wireless remote-control model in accordance with the present invention, FIG. 2 for a schematic view of a stop mechanism for limiting the maximum rotation angle of a servomotor, and FIG. 3 for a schematic view of an appearance of a potential meter. In FIG. 1, a servomotor 1 is installed at a body frame 6 of a radio control helicopter. In this embodiment, the servomotor 1 constitutes an aileron controlled servo apparatus. At the position of the servomotor 1, a potential meter 1A (as shown in FIG. 3) is installed coaxially onto a rotary axle (or a rotary axle driven by a pulse for a step rotation) of a retarded servomotor 1. The potential meter 1A is replaceably installed onto a rotary axle protruded from an opposite side of the output shaft 20 of the servomotor 1 or fixed into the frame body 6 of the servomotor 1.

In the output shaft 20 of the servomotor 1 of this embodiment as shown in FIG. 1, the cross-section of a protruded portion latched with a servo rudder piece 40 is substantially in a quadrangular prism shape, and a sidewall of the output shaft 20 in a prism shape forms a convex bar 20A extended towards the installation direction of the servo rudder piece 40. The convex bar 20A is an indicator of the neutral position, and it also has the function of limiting the installation direction of the servo rudder piece 40 to a single direction to prevent the installed portion of the output shaft 20 and the servo rudder piece 40 from being loosened, wherein the output shaft 20 is in a quadrangular prism shape. The convex bar 20A is in a rod shape formed on a sidewall, but the present invention is not limited to such arrangement. The cross-section of the output shaft 20 can be in a triangular, pentagonal, or polygonal shape, or a non-circular cross-section. Further, the shape and the quantity of the convex bars 20A may vary freely.

An embedding hole 50 is formed at the position of the servo rudder piece 40 for inserting and installing the output shaft 20 of the servomotor 1, and a bottom wall having a screw hole 50D is formed at the top of the embedding hole 50, and the top of the output shaft 20 abuts the bottom wall to restrict the installation height of the servo rudder piece 40. In this assembly, a connecting rod latching hole 50B,50C is formed at a predetermined distance from the embedding hole 50 of the servo rudder piece 40, but the servo rudder piece comes with various shapes and latching holes corresponding to its controlled target. Further, a screw hole 20B is formed at the top of the output shaft 20 for passing a screw (not shown in the figure) from an external side of the screw hole 50D at the top of the embedding hole 50 and secured to the screw hole 20B of the output shaft 20. The left and right maximum rotation angles of the servomotor 1 are limited by a mechanical stop mechanism composed of a rotary-side rotation angular component on a side of the rotary axle of the servomotor, and a fixed-side rotation angle limit component at a side of the housing of the servomotor.

In FIG. 2, the stop mechanism is composed of a fixed-side rotation angle limit component 60 installed at a frame body 80, and a rotary-side rotation angular component 70 fixed onto a rotary axle (output shaft) of the servomotor 1. The rotary-side rotation angular component 70 is rotably and freely assembled to an internal side of the fixed-side rotation angle limit component 60. The fixed-side rotation angle limit component 60 forms a withdrawn section difference 60A withdrawn from the center of the output shaft 20 to the external side, and the rotary-side rotation angular component 70 forms a protruded section difference 70A protruded from the center of the output shaft 20 the external side.

When the output shaft 20 of the servomotor 1 is installed into the embedding hole 50 of the servo rudder piece 20, the installation posture is determined by the cross-sectional shape of the output shaft 20 and the embedding hole 50. By then, not only the external sidewall of the output shaft 20 in a prism shape is coupled with the internal sidewall of the embedding hole 50, but the convex bar 20A and concave bar 50A are also engaged, so that a higher installation precision can be achieved. FIG. 4 shows that the closer to the cross-section of the convex bar 20A, the larger is the root portion of the output shaft 20. As a result, the servo rudder piece 40 can be fixed securely onto the output shaft 20. This idea can be applied to the output shaft 20 as well. The length of the output shaft is exaggerated in FIG. 4 simply for the illustration purpose.

In a neutral position of a servomotor output shaft 20 as shown in FIG. 2, the rotation angle range θ of a rotary surface in the output shaft 20 in a direction (such as a left rotation direction) and an opposite direction (such as a right rotation direction) is mechanically set to the same angle. The servomotor has a fixed-side rotation angle limit component 60 on a side of the frame body for limiting the maximum rotation angle of the output shaft 20 of the servomotor 1 in a direction (such as the left-side direction as shown in FIG. 2) and the maximum rotation angle in an opposite direction (such as the right-side direction as shown in FIG. 2). The fixed-side rotation angle limit component 60 can be formed by punching an appropriate board, or fixed into the frame body 80, or integrally formed at a portion of the frame body 80.

Further, a rotary-side rotation angle limit component 70 is installed at a position where the output shaft 20 of the servomotor 1 is connected to the rotary axle for limiting the position of a maximum rotation angle in a direction of the output shaft and a maximum rotation angle in an opposite direction. The rotary-side rotation angle limit component 70 is a component formed separately from a rotating member (rotor) of the servomotor 1, or manufactured as a portion of the rotating member. The structure of the fixed-side rotation angle limit component 60 and the rotary-side rotation angle limit component 70 is not limited to that illustrated by the drawings, but it can be composed of simple protruding members connected with each other. Further, the rotation angle limit component can be installed at a connected and operated portion.

After the neutral position is set mechanically, a standard neutral position sets the medial of each output value of the potential meter as the standard neutral position of the output shaft 20 of the servomotor 1, if the output shaft 20 of the servomotor 1 is rotated at the aforementioned direction and situated at a position of the maximum rotation angle in the aforementioned opposite direction (which is the position of the rotary-side rotation angle limit component 70 abutting and connecting the fixed-side rotation angle limit component 60), and the sequence of the procedure is described as follows.

After the servo rudder piece 40 is installed to the output shaft 20 of the servomotor 1, a simple automatic neutral position setup operation (standard auto-correction) is performed to set the neutral position, and the simple automatic neutral position setup operation comprises the steps of:

(1) starting the correction from the personal computer (PC) or a device installed to a body frame;

(2) starting to rotate the output shaft (rotary axle) of the servomotor in any direction;

(3) stopping the rotary axle by limiting the assembly of the fixed-side rotation angle limit component 60 and the rotary-side rotation angle limit component 70 to its maximum rotation angle, and reading the resistance value by potential meter 1A when the servomotor is situated at a stop position.

The foregoing procedure is repeated for several times, and the average resistance obtained by the potential meter 1A within this time period is set as the resistance value of the maximum rotation position. The operation is performed for both left and right rotation directions, such that the median of resistance values of the maximum rotation position in left and right rotation directions of the potential meter is set as the neutral position of the output shaft. The potential meter is used for measuring the resistance value of the maximum rotation position, but the invention is not limited to such arrangement, and any other current value, or testing mechanisms such as an optical mechanism or a magnetic testing mechanism can be used instead, and the testing mechanism for the maximum rotation position will not be described here.

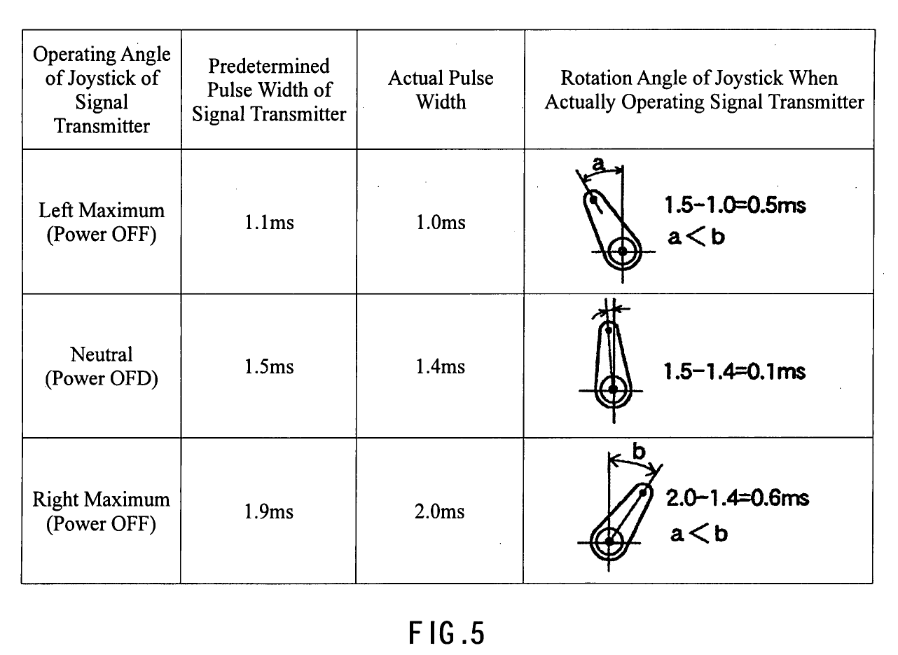

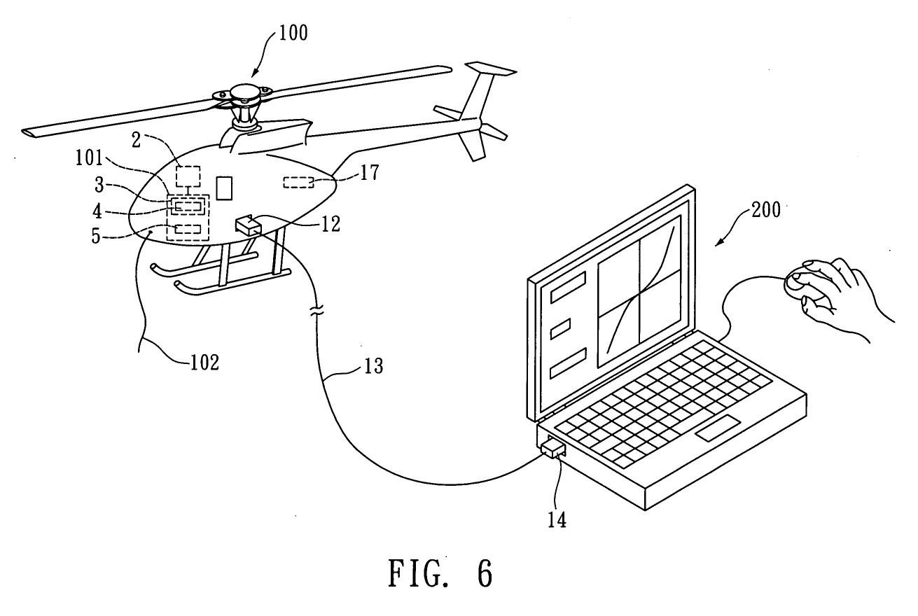

Referring to FIG. 5 for a schematic view of an output pulse content of a signal transmitter and a position of a servo rudder piece when the neutral position is set automatically and simply in accordance with a preferred embodiment of the present invention, the predetermined pulse width and the actual pulse width (which is the pulse width when the signal transmitter is operated), the operating angle (left maximum, neutral and right maximum) of the joystick of the signal transmitter, and the rotation angle of the servomotor when the joystick of the signal transmitter is actually operated are shown, and the POWER OFF in the column of the operating angle of the joystick of the signal transmitter as shown in FIG. 5 indicates a status of non-transmitted waves.

The error of the neutral position obtained after implementing the aforementioned correction standard is much smaller than the error of the prior art servomotor teeth, which is sufficient for the applications, but the automatic high-precision neutral position setup (or automatic high-precision correction, hereinafter referred to as “Automatic High-Precision Setup”) is conducted for a stricter precision, In the automatic high-precision setup, a very small discrepancy of the neutral position signal (neutral pulse wave) of each control channel of the signal transmitter is compensated and corrected, and a communication line is used for connecting the wireless remote-control model and the signal transmitter for transmitting electric waves from the signal transmitter to the wireless remote-control model, when both signal transmitter and wireless-control model are powered on.

Further, the same measure is taken, such that the neutral point obtained by the standard auto-setup operation and the neutral position signal of each control channel of the signal transmitter are consistent, and such operating sequence as described as follows. The resistance value of the potential meter when operating at a maximum rotation angle is consistent with the control pulse wave of the operating joystick of the signal transmitter when operating at its maximum, so as to achieve the linearity of a full range coverage of an operating joystick of the signal transmitter and the output of the servomotor can be achieved.

Referring to FIG. 6 for a schematic view of a system assembly when a wireless remote-control model sets a neutral position automatically and precisely in accordance with a preferred embodiment of the present invention, a central controller (CPU) 3, a set value storage (memory) 4, a control signal manufacture portion 5 and other loops are installed at a position for driving the control loop 101 of the radio control helicopter 100. The radio control helicopter 100 has a connector 12, and a communication line 13 connected between a connector 14 of PC and an external device. The signal receiver 2 has a high-frequency (RF) processing portion 2A, a wave detection portion and a decoding portion 2B, and 17 stands for a battery.

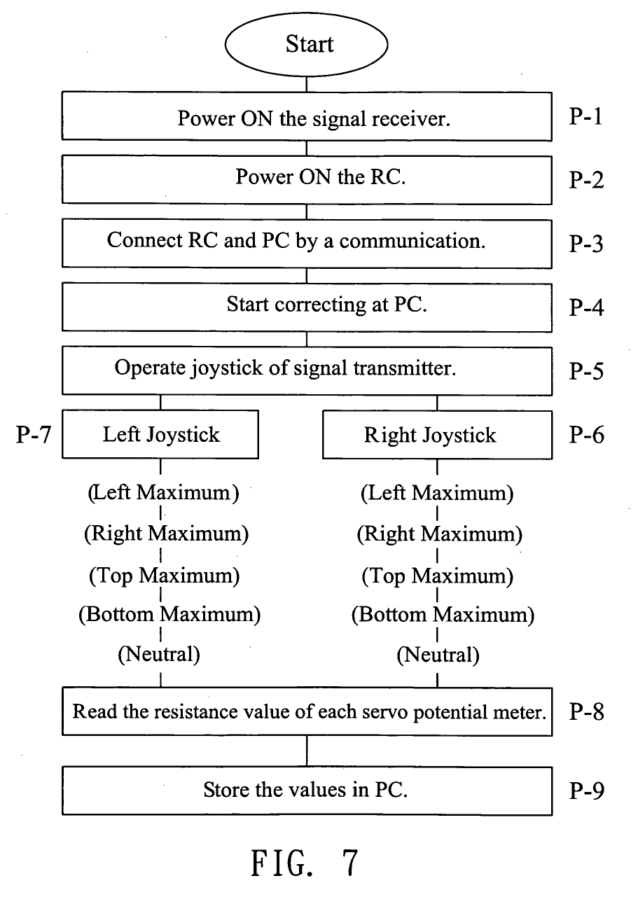

Referring to FIG. 7 for a flow chart of a sequence for setting a neutral position of a wireless remote-control model automatically and precisely in accordance with a preferred embodiment of the present invention, the signal transmitter of an assembly as shown in FIG. 6 is powered ON (P-1). The main power supply of the radio control helicopter (RC) 100 is turned on (P-2). The communication line is connected to the PC 200 and the radio control (RC) helicopter 100 (P-3). The correction of neutral position is started on the PC 200 (P-4). The joystick of the signal transmitter is operated to read the numeric value of the potential meter (P-5). The right joystick is operated (P-6) to read the numeric values of the potential meter at the left maximum position, the right maximum position, the top maximum position, the bottom maximum position, and the neutral position (P-8). The left joystick is operated (P-7) to read the numeric values of the potential meter at the left maximum position, the right maximum position, the top maximum position, the bottom maximum position, and the neutral position (P-8). The aforementioned results are stored in the PC (P-9).

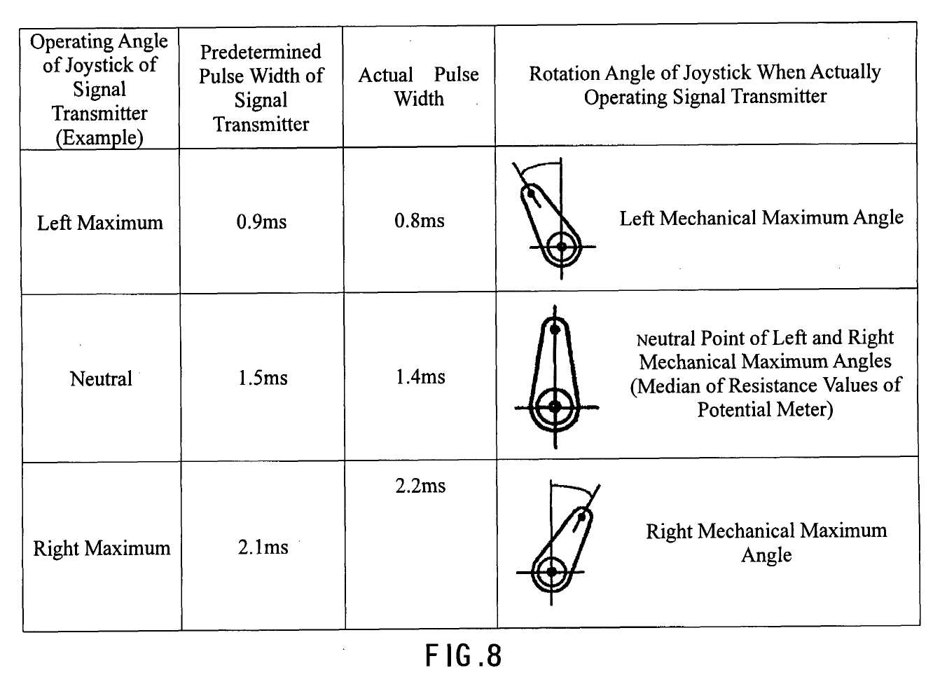

Referring to FIG. 8 for a schematic view of the content of an input pulse from a signal transmitter and the position of a servo rudder piece when a neutral position is set automatically and precisely in accordance with a preferred embodiment of the present invention, the predetermined pulse width and the actual pulse width (which is the pulse width when the signal transmitter is operated), the operating angle (left maximum, neutral and right maximum) of the joystick of the signal transmitter, and the rotation angle of the servomotor when the joystick of the signal transmitter is actually operated are shown.

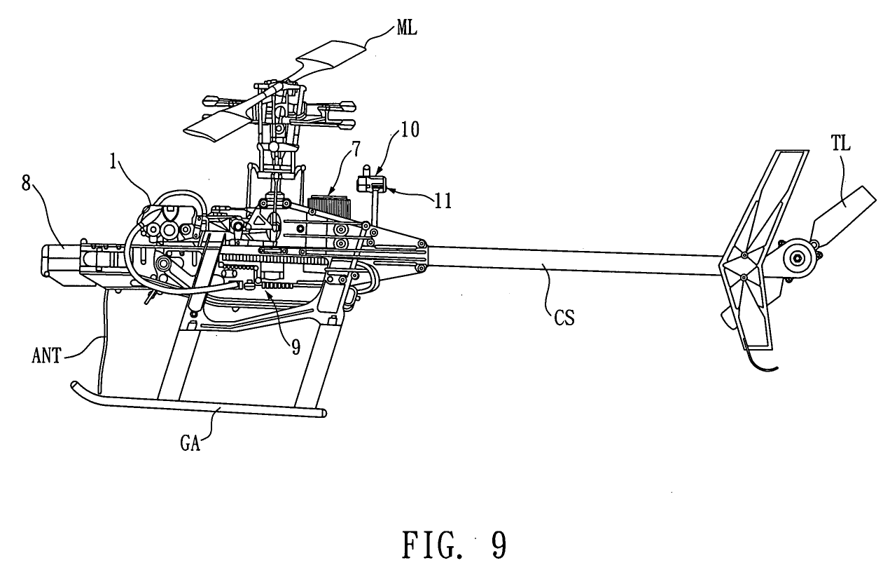

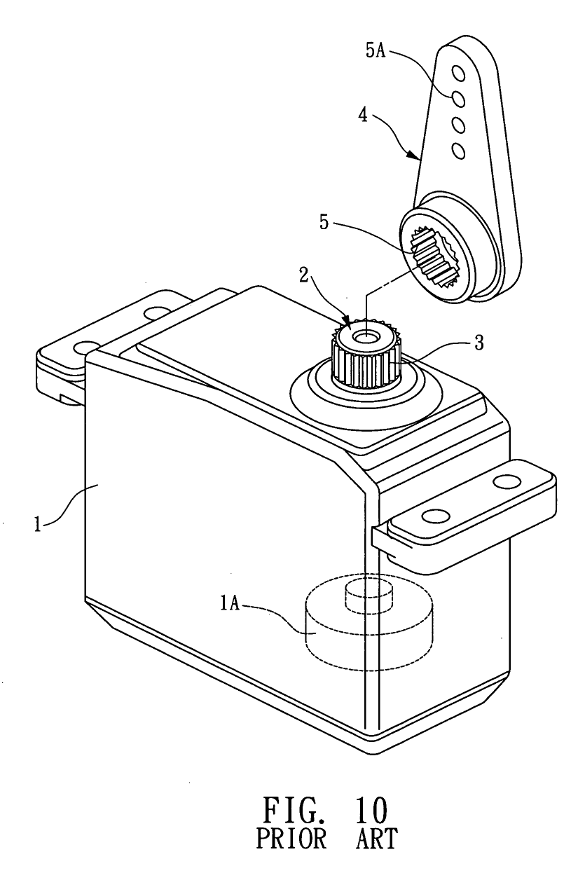

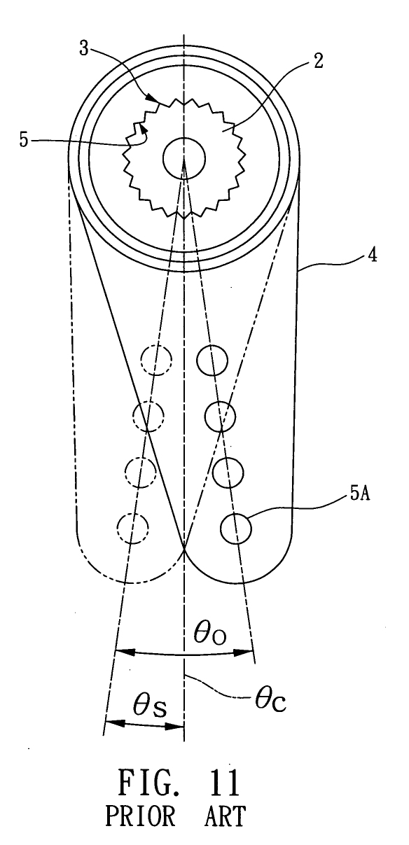

Referring to FIG. 9 for an overall view of a radio control helicopter applicable for a wireless remote-control model in accordance with the present invention, a control mechanism having an action motor 7, a battery 8, a servomotor 1 or a gyroscope is installed on the frame body of the radio control helicopter, and a main rotor ML and a gear GA are installed at the body frame, and a tail rotor TL is installed at the axle body CS. The control mechanism or action motor is activated by a start button 10, and the control instruction is received by an antenna ANT for controlling the control mechanism for implementing the flying operation.

This invention is not limited to an application to a radio control helicopter only, but also applicable for other wireless remote-control models. Further, the invention has the advantage of allowing a user to recur the neutral status of a servomotor, even when the user changes the potential meter.

In view of the detailed description above, the present invention can be achieved by those ordinarily skilled in the art and is in compliance with the requirements of patent application, and thus is duly filed for patent application.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A servomotor neutral position setting apparatus of a wireless remote-control model, comprising:
a servomotor, having an output shaft that rotates within a predetermined angular range in a frame body;
a servo rudder piece, having an embedding hole for embedding said output shaft, and a latching hole for latching a link rod connected to a controlled component; and
a potential meter, installed and rotated coaxially with said output shaft of said servomotor;
thereby, the portion where said output shaft of said servomotor embedded into at least one embedding hole of said servo rudder piece is a prism, and at least one surface of the external sidewall of said prism has a convex bar formed in a direction parallel to an inserting direction of said embedding hole of said servo rudder piece;
said embedding hole of said servo rudder piece is an angular hole for embedding said output shaft of said servomotor prism, and at least one surface of the internal sidewall of said angular sidewall has a concave bar formed in the same direction of said convex bar on the external sidewall of said output shaft and embedded to said convex bar;
a fixed-side rotation angle limit component is disposed on a lateral side of said frame body and has for limiting a maximum rotation angle in a direction and an opposite direction of said output shaft of said servomotor, while a rotary-side rotation angle limit component is disposed on a lateral side of said output shaft for limiting a maximum rotation angular position in a direction and a maximum rotation angle in an opposite direction of said output shaft;
characterized in that the median of each output value of said potential meter is determined to be a standard neutral position of said output shaft of said servomotor, when said output shaft of said servomotor is situated at a position of the maximum rotation angle in said direction and said opposite direction.

2. The servomotor neutral position setting apparatus of a wireless remote-control model as recited in claim 1, wherein said prism is a quadrangular prism, and said convex bar has a cross section substantially in a circular or elliptic shape, and said prism is in a shape of having a lateral portion coupled to an external sidewall of said prism and buried into said external side wall.

3. The servomotor neutral position setting apparatus of a wireless remote-control model as recited in claim 2, wherein said convex bar has a cross section tapered from the base of said prism.
